(19) United States
(12) Patent Application Publication
(10) Pub. No.: US 2014/0138295 A1
(43) Pub. Date: May 22, 2014

(54) HALOGEN ADSORBENT, TANK FOR WATER TREATMENT, AND WATER TREATMENT SYSTEM

(71) Applicant: Kabushiki Kaisha Toshiba, Minato-ku (JP)

(72) Inventors: Tomohito IDE, Tokyo (JP); Yumiko SEKIGUCHI, Kanagawa (JP); Arisa YAMADA, Kanagawa (JP); Hideyuki TSUJI, Kanagawa (JP)

(73) Assignee: Kabushiki Kaisha Toshiba, Minato-ku (JP)

(21) Appl. No.: 14/083,793

(22) Filed: Nov. 19, 2013

(30) Foreign Application Priority Data
Nov. 19, 2012 (JP) 2012-253494
Oct. 8, 2013 (JP) 2013-211380

(51) Int. Cl. C02F 1/28

(52) U.S. Cl. CPC C02F 1/288
USPC 210/96.1; 210/287; 252/181

(57) ABSTRACT

A halogen adsorbent of an embodiment includes: a halogen adsorbent including a support, a chelate ligand bonded to the support, and a metal ion coordinated on the chelate ligand. The chelate ligand has a functional group represented by —NR¹—(CH₂CH₂NR³)ₙ—R², all of the R¹, R², and R³ are hydrogen atoms and the n is 1 or 2, or at least any one of the R¹, R², and R³ is a functional group represented by —CH₂CH₂CONR⁴R⁵, the R⁴ and R⁵ are selected from hydrogen atom, an alkyl group and an alkyl ether group including a straight chain or a side chain having 1 to 6 carbon atoms, and the n is any of 0, 1, and 2.

### CROSS-REFERENCE TO RELATED APPLICATION

This application is based upon and claims the benefit of priority from Japanese Patent Applications No. 2012-253494 Nov. 19, 2012 and Japanese Patent Applications No. 2013-211380 Oct. 8, 2013; the entire contents of which are incorporated herein by reference.

### FIELD

Embodiments described herein relate generally to a halogen adsorbent, a tank for water treatment, and a water treatment system.

### BACKGROUND

Halogen elements (fluorine, chlorine, bromine, iodine) exhibits high reactivity and a strong oxidation power, and exhibits a strong electron-withdrawing property in the molecules, and thus have been used widely for not only advanced materials and medical products, but also intermediate materials for chemical products, general-purpose materials, and the like. However, for example, fluorine is an environmental pollutant for which environmental standards are established, and when fluorine is mixed in discharged water, the removal of the fluorine is required. While the standard of water-purity for tap water provides that chlorine should be 200 mg/L or less in terms of chloride ion, chlorine is usually not problematic because the reference value is relatively high. The release of bromine and compounds thereof into the environment causes water pollution. Bromine-contaminated water generates a highly cancer-causing bromic acid by advanced water treatment with ozone. The standard of water-purity for tap water is 10 μg/L regarding the bromic acid, which is extremely low, and when raw water is contaminated with bromine, the advanced water treatment is not able to be applied practically. Iodine needs to be collected from discharged water and recycled, because of small amounts of naturally condensed resources for iodine and environmental regulations tightened in recent years. In addition, radioactive iodine is released in a nuclear accident, and then dissolved in rainwater to flow into rivers or lakes. For this reason, radioactive iodine is problematically mixed in tap water. In addition, although it is possible to adsorb halide ions with the use of an ion-exchange resin, the resin generally has no element selectivity for trapping all of anions, and it is difficult to selectively collect specific halogen ions.

In the case of fluorine, it is possible to selectively and inexpensively remove fluorine, because fluorine forms poorly soluble calcium fluoride (CaF₂) with calcium.

As for the toxicity of chlorine, depending on the chemical form, for example, chloride ions contained in wastewater have low toxicity, and generally requires no treatment. In addition, there is an abundance of resources for chlorine, and there is thus a reduced need for adsorption or collection.

It is difficult to selectively adsorb and collect bromine by a precipitation method or with the use of an adsorbent. It is to be noted that when bromine is oxidized to turn to bromine acid, the bromine acid can be adsorbed by metal hydroxide.

In the case of iodine, activated carbon- or zeolite-supported silver can be used to selectively adsorb iodine. The supported silver has iodide ion selectivity, but show a low adsorption capacity. Furthermore, activated carbon-supported silver is produced by immersing activated carbon in a solution containing silver ions, while the amount of supported silver is not be able to be increased because silver ions are likely to be eluted in water. In addition, zeolite-supported silver is produced by cation exchange, there is thus possibility that ion exchange will again take place in the presence of other cations to elute silver. Besides, silver is a noble metal, and thus has the problem of high cost.

### BRIEF DESCRIPTION OF THE DRAWINGS

FIG. 1 is a conceptual diagram of a water treatment system with the use of a halogen adsorbent according to an embodiment.

FIG. 2 is a conceptual diagram of a tank for water treatment according to an embodiment, which is connected to piping.

FIG. 3 is a diagram of UV-Vis spectra for samples with chloride ions, bromide ions, and iodide ions respectively adsorbed on a halogen adsorbent according to Example 9.

FIG. 4 is a diagram of UV-Vis spectra for samples obtained by immersing a halogen adsorbent according to Example 9 in solutions containing different concentrations of iodide ions.

FIG. 5 is a diagram of UV-Vis spectra for samples with iodide ions adsorbed on a halogen adsorbent according to Example 9 in coexistence with chloride ions or bromide ions.

### DETAILED DESCRIPTION

A halogen adsorbent of an embodiment includes: a halogen adsorbent including a support, a chelate ligand bonded to the support, and a metal ion coordinated on the chelate ligand. The chelate ligand has a functional group represented by —NR¹—(CH₂CH₂NR³)ₙ—R², all of the R¹, R², and R³ are hydrogen atoms and the n is 1 or 2, or at least any one of the R¹, R², and R³ is a functional group represented by —CH₂CH₂CONR⁴R⁵, the R⁴ and R⁵ are selected from a hydrogen atom, an alkyl group and an alkyl ether group including a straight chain or a side chain having 1 to 6 carbon atoms, and the n is any of 0, 1, and 2.

Embodiments will be described below with reference to the drawings.

The halogen adsorbent according to an embodiment includes a support, a chelate ligand bonded to the support, and a metal ion coordinated on the chelate ligand.

The ligand preferably has a functional group represented by the following chemical formula (1).

[Chemical Formula 1]

—NR¹—(CH₂CH₂NR³)ₙ—R² (1)

Examples of the support according to an embodiment include metal oxides, cellulose, and polyvinyl alcohol. These supports have, at the surfaces thereof, a lot of hydroxyl groups, and adequate strengths as the support for the adsorbent. The hydroxyl groups at the surfaces thereof serve as functional groups for bonding to the ligand.

The metal oxide supports include silica (SiO₂), titania (TiO₂), alumina (Al₂O₃), and zirconia (ZrO₂), ferrous oxide (FeO), ferric oxide (Fe₂O₃), ferrosoferric oxide (Fe₃O₄), cobalt trioxide (CoO₃), cobalt oxide (CoO), tungsten oxide (WO₃), molybdenum oxide (MoO₃), indium tin oxide (In₂O₃—SnO₂:ITO), indium oxide (In₂O₃), lead oxide (PbO₂), niobium oxide (Nb₂O₅), thorium oxide (ThO₂), tantalum oxide (Ta₂O₅), rhenium trioxide (ReO₃), chromium oxide (Cr₂O₃), and besides, oxo metalates such as zeolite (aluminosilicate), lead zirconate titanate (Pb(ZrTi) O₃: PZT), calcium titanate (CaTiO₃), lanthanum cobaltate (LaCoO₃), lanthanum chromate (LaCrO₃), and barium titanate (BaTiO₃), or alkoxides and halides forming the metalates.

Among the supports mentioned above, the silica, titania, alumina, zirconia, and zeolite have the advantages of being inexpensive, having a high proportion of hydroxy group at the surfaces, and being able to have many ligands modified on the supports.

The size of the support in the present embodiment is preferably 100 μm or more and 5 mm or less in average primary particle size. When the average primary particle size of the support is adjusted to 100 μm or more and 5 mm or less, a balance can be achieved between a high rate of filling a column, a cartridge, or a tank with the halogen adsorbent and ease of passing water, for example, in the case of carrying out halogen adsorption. If the average primary particle size is less than 100 μm, the rate of filling a column or the like with the halogen adsorbent will be excessively increased to decrease the void ratio, thus making water less likely to be passed. On the other hand, if the average primary particle size is greater than 5 mm, the rate of filling a column or the like with the halogen adsorbent will be excessively deceased to increase the void, thus making water more likely to be passed, but decrease the area of contact between the halogen adsorbent and discharged water containing halogen, thus decreasing the rate of halogen adsorption by the halogen adsorbent. Preferred supports are 100 μm or more and 2 mm or less, more preferably 300 μm or more and 1 mm or less in average primary particle size.

The average particle size can be measured by a sieving method. Specifically, the size can be measured by sieving with the use of multiple sieves between 100 μm and 5 mm in mesh size, in accordance with JISZ 8901:2006 “Powder for Test and Particle for Test”.

It is to be noted that in the case of the halogen adsorbent according to the present embodiment, the shape of the adsorbent itself can be adjusted just by changing the shape of the support, and it is determined that the shape of the support may be placed in a desired shape in order to obtain an easy-to-handle adsorbent. More specifically, an easy-to-handle halogen adsorbent can be obtained without carrying out operations such as granulation or shape forming. In addition, because there is no need to carry out granulation, shape forming, or the like, a manufacturing process can be simplified which is required to obtain an easy-to-handle halogen adsorbent, and cost reduction can be achieved.

The ligand according to the embodiment has a functional group represented by —NR¹—(CH₂CH₂NR³)ₙ—R², which is bonded to the hydroxyl group of the support. The support and the ligand are bonded by a coupling reaction such as, for example, a silane coupling reaction. The following is preferred for the functional group of the ligand: where R¹, R², and R³ are all hydrogen atoms, and n is 1 or 2, or where at least any one of R¹, R², and R³ is a functional group represented by —CH₂CH₂CONR⁴R⁵, R⁴ and R⁵ are a hydrogen atom or an alkyl group or an alkyl ether group including a straight chain or a branched chain having 1 to 6 carbon atoms, and n is any one of 0, 1, and 2. R¹, R², and R³ which are not a functional group represented by —CH₂CH₂CONR⁴R⁵ are hydrogen atom.

First, a case will be described where R¹, R², and R³ are all hydrogen atoms in the functional group represented by —NR¹—(CH₂CH₂NR³)ₙ—R². Chemical Formula (2) shows a conceptual structural formula of a halogen adsorbent in the case where R¹, R², and R³ are all hydrogen atoms. In Chemical Formula (2), when R¹, R², and R³ are all hydrogen atoms, n is preferably 1 or 2 in order for the ligand to form a chelate with the metal ion. When n is 0, the ligand is not able to form any chelate. It is to be noted that n of 3 or more is not preferred from the perspective of having the possibility of forming a dinuclear complex with the metal valence changed. The chelate ligand according to the embodiment forms a chelate complex with the metal ion, which is rigidly bonded, and can suppress metal elution even in water.

The halogen adsorbent including the ligand where R¹, R², and R³ are all hydrogen atoms, and n is 1 or 2 can be obtained by reacting the support with a coupling agent having the functional group of the ligand. When n is 1 or 2, commercially available inexpensive silane coupling agents (for example, N-(2-aminoethyl)-3-aminopropyltrimethoxysilane) can be used for the introduction of the ligand to the support surface.

The halogen adsorbent described above adsorbs bromine, iodine, and chlorine as halogen ions. Among the halogen ions, bromine can be selectively adsorbed.

Next, a case will be described where at least any one of R¹, R², and R³ is a CH₂CH₂CONR⁴R⁵ group in the functional group represented by —NR¹—(CH₂CH₂NR³)ₙ—R². Chemical Formula (3) shows a conceptual structural formula in this case. In this case, more favorable halogen adsorption capacity and selectivity are exhibited than in the case where R¹, R², and R³ mentioned above are all hydrogen. R⁴ and R⁵ are a hydrogen atom, or an alkyl group or an alkyl ether group including a straight chain or a branched chain having 1 to 6 carbon atoms, and n is preferably any one of 0, 1, and 2. When n is 0, R³ is ignored.

The halogen adsorbent including the ligand where at least any one of R¹, R², and R³ is a CH₂CH₂CONR⁴R⁵ group is produced by a method of reacting the support with a coupling agent and reacting the coupling agent modified support with an acrylamide, or a method of reacting a coupling agent with an acrylamide and reacting the acrylamide modified coupling agent with the support. When n is any one of 0, 1, and 2, the acrylamide can be selected from inexpensive acrylamides, depending on the derivative of the acrylamide (for example, acrylamide, N-isopropylacrylamide) for use in the case of modification with the functional group. As the coupling agent, a silane coupling agent is preferred

The halogen adsorbent described above adsorbs bromine, iodine, and chlorine as halogen ions. Among the halogen ions, iodine can be selectively adsorbed.

The halogen adsorbent according to the present embodiment has the metal ion supported on the chelate ligand. Ions of the iron group (Fe, Ni, Co), group 11 (Cu, Ag, Au), and group 12 (Zn, Cd, Hg) can be used as the metal ion. Among the ions, divalent copper ions are preferred as the metal ion.

The metal ion described above is supported by immersing the support in a solution with a metal salt dissolved therein. As the metal counterion, counterions forming water-soluble salts are preferred such as chloride ions, nitrate ions, sulfate ions, perchlorate ions, acetate ions, trifluoroacetate ions, methanesulfonate ions, trifluoromethanesulfonate ions, toluenesulfonate ions, hexafluorophosphate ions, and tetrafluoroborate ions, and among the counterions, nitrate ions and sulfate ions are particularly preferred because of being inexpensive and safe, and forming no anionic metal complex. These counterions are contained in the halogen adsorbent.

The metal salt used may be a metal complex salt. As a ligand of the metal complex salt, electrically neutral ligands are preferred such as nitrogen-containing ligands such as ammonia, pyridine, ethylenediamine, and N,N′-dimethylethylenediamine, and phosphorous-containing ligands such as triphenylphosphine, tetraphenylphosphinoethane, and tetraphenylphosphinopropane, and complex salts having a nitrogen-containing ligand are preferred because of their inexpensiveness and stability. For these metal complex salts, commercially available salts can be also directly used, and similar effects can be also achieved by adding the ligand in a metal supporting step.

The case of the halogen adsorbent according to the present embodiment has the metal ion forming the adsorbent, which is considered to adsorb halogen ions in discharged water. More specifically, halogen (X) is present in the form of anions such as halide ions (X⁻), polyhalide ions (X₃⁻, X₅⁻), and halogen acid ions (XO₃⁻) in discharged water, and such anions are considered to be ion-exchanged for the counterion of the metal ion in the halogen adsorbent, and linked with a coordination bond, thereby achieving halogen adsorption in the discharged water. Further, it is possible to adsorb, besides halogen ions, general anions such as carbonate ions, phosphate ions, arsenate ions, and arsenite ion, while the selectivity of anion adsorbed is determined by the metal ion. In the case of using copper ions, bromide ions and iodide ions are preferably adsorbed which are halogen ions.

Next, conceptual structural formulas for the halogen adsorbent according to the present embodiment are represented by Chemical Formulas (2) to (5) by way of example, and conceptual structural formula for the adsorbing of iodine by the halogen adsorbent by way of example. It is to be noted that the leftmost circles in the chemical formulas represent supports.

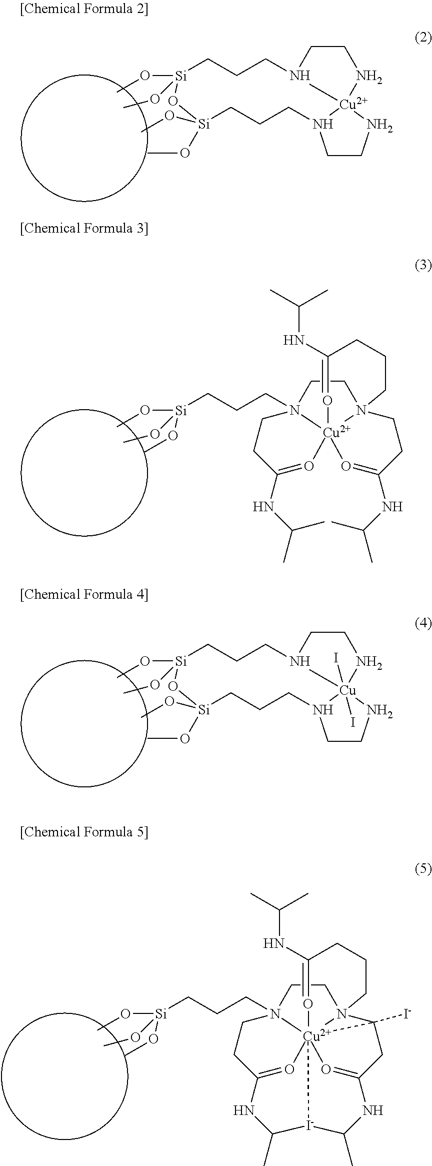

Chemical Formula (2) is an example where n in Chemical Formula (1) is 1, and a copper ion is supported on a chelate ligand with hydrogen as R¹, R², and R³, whereas Chemical Formula (3) is an example where n is 1, and a divalent copper ion is supported on a chelate ligand with CH₂CH₂CONR⁴R⁵ groups as R¹, R², and R³, hydrogen as R⁴, and an isopropyl group as R⁵. Further, Chemical Formula (4) represents the halogen adsorbent of Chemical Formula (2) which adsorbs iodine present in the form of anion with a coordination bond in discharged water, whereas Chemical Formula (5) represents the adsorbent of Chemical Formula (3) which adsorbs iodine in a similar fashion. The adsorbents by the chemical formulas are by way of example, and the embodiment, which are not to be considered limited to the adsorbents mentioned above, also encompasses, for example, a compound in the form of a divalent copper ion supported on a chelate ligand with n of 1, CH₂CH₂CONR⁴R⁵ groups for two of R¹, R², and R³ and hydrogen for the other one thereof, hydrogen for R⁴, and an isopropyl group for R⁵. In addition, compounds which all have the same structure are not always obtained depending on the reaction, and the embodiment thus also encompasses adsorbents which have multiple kinds of structures.

It is to be noted that the structures mentioned above are consistently estimated structures, and the coordination state of actual metal ions and iodine has not been clarified yet right now.

In addition, it has been confirmed from ion chromatography that halogen is adsorbed by ion exchange of halogen ions for counterions of copper ions. More specifically, in the case of a halogen adsorbent with cupric nitrate supported, nitrate ions are detected from tested water after halogen adsorption.

Further, the chelate ligand also has another effect besides strong immobilization of the metal. The bonding energy of an nitrate ion is obtained as −56 kcal/mol and −21 kcal/mol respectively in the non-chelate complex represented by Chemical Formula (6) and the chelate complex represented by Chemical Formula (7). More specifically, it has been found by quantum-chemical calculation for a model complex that the chelate ligand has the effect of reducing the bonding energy of the counterion to promote ion exchange.

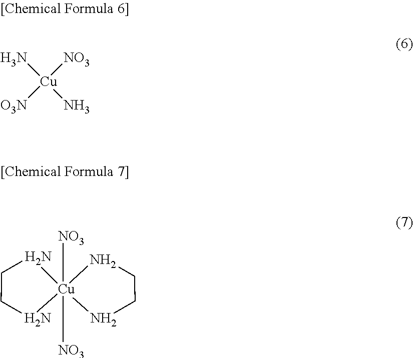

In addition, the structure of the chemical formula (3) is sterically hindered, and simply considered disadvantageous for adsorption of iodide ions that are large in ionic radius, and in coexistence with, for example, smaller chlorine ions, the selectivity of iodine has been considered to be decreased. Therefore, the adsorption energy has been estimated by quantum-chemical calculation for the iodine and chlorine in the model complex of Chemical Formula (8). As a result, the adsorption energy of the iodine is −9.9 kcal/mol, whereas the adsorption energy of the chlorine is only −2.2 kcal/mol. More specifically, it has been determined that iodine is unexpectedly more likely to be adsorbed. This is construed as due to van der Waals force strongly acting between iodide ions and the alkyl chain, because the iodide ions has larger polarizability than chloride ion due to soft and large electron cloud. Further, natural orbital analysis has confirmed that both anions of iodine and chlorine interact with copper.

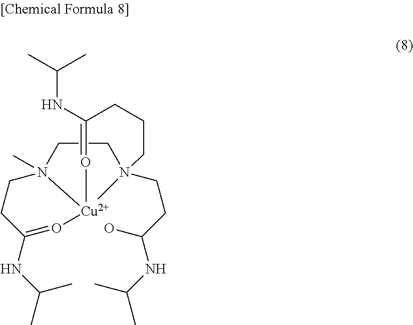

The quantum-chemical calculation mentioned above has been performed by density functional theory using ωB97X-D functional with basis sets of 6−31+G(d′) (for hydrogen, carbon, nitrogen, oxygen, and chlorine), LANL2DZ (f) (for copper), and LANL2DZpd (for iodine). The solvation effect of water was considered by IEF-PCM (integral equation formalism version of polarizable continuum model) method. All calculations were carried out with Gaussian 09 package.

(Color Reaction of Halogen Adsorbent)

Furthermore, when at least two of R¹, R², and R³ contain a ligand substituted with a CH₂CH₂CONR⁴R⁵ group with n=1 in the functional group represented by —NR¹—(CH₂CH₂NR³)ₙ—R² as a ligand, and when the supported metal ions are copper ions, halogen ion detection and monitoring of adsorption amount can be performed. More specifically, in the case of adsorbing bromide ions, the adsorbent which is blue before the adsorption is changed to blue-green after use. In the case of iodide ions, the adsorbent is more markedly changed from blue to green. It is to be noted that the degree of change in color depends on the proportion and absolute amount of the ligand contained in the adsorbent, and the adsorbed amounts of bromine and iodine.

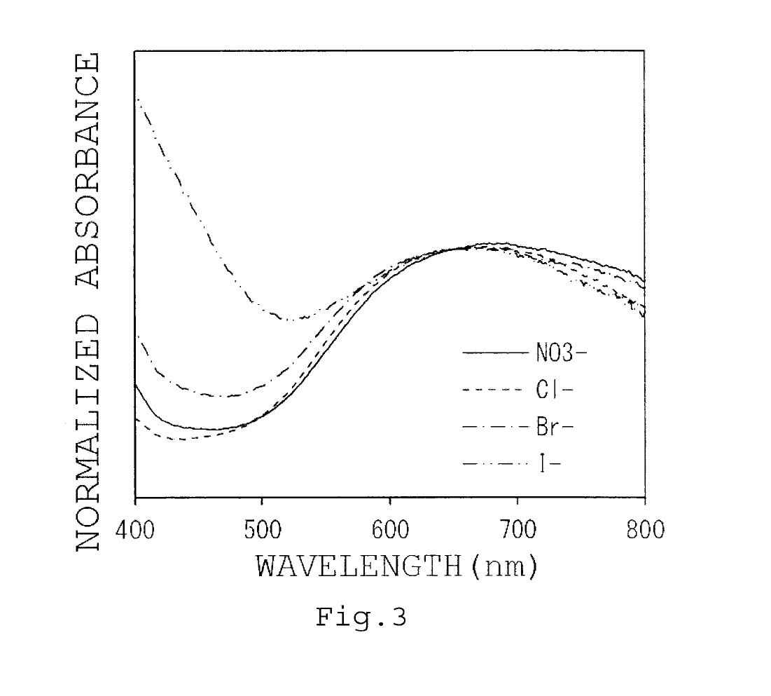

FIG. 3 shows respective UV-Vis (ultraviolet-visible) spectra (normalized with the absorbance at 650 nm) for a halogen adsorbent containing a CH₂CH₂CONHCH₂O(CH₂)₃CH₃ group as a substituent for R¹, R², and R³, a halogen adsorbent with chlorine adsorbed thereon, a halogen adsorbent with bromine adsorbed thereon, a halogen adsorbent with iodine adsorbed thereon, and a halogen adsorbent with chloride ions adsorbed thereon. The change in spectrum shape is small in the case of the chlorine adsorption, as compared with the iodine adsorption or bromine adsorption. It is determined that the absorbance is increased in the range from 400 nm to 600 nm in the case of the bromine adsorption. Also in the case of the iodine adsorption, the absorption is increased in the range from 400 nm to 600 nm, and the degree of increase is higher than in the bromine adsorption. As a result, the halogen adsorbent turns from blue to blue-green in bromine adsorption, and undergoes a change in color from blue to green in iodine adsorption. In addition, it is determined that the halogen adsorbent described above undergoes a change in color from blue to blue-purple in chlorine adsorption, although the change in color is small.

From the results mentioned above, the bromine adsorption, iodine adsorption, and chlorine adsorption can be monitored by tracking the ratio between the absorbance, for example, at 450 nm in the range from 400 nm to 600 nm, and the absorbance, for example, at 650 nm outside the range from 400 nm to 600 nm. It is to be noted that the iodine adsorption can be monitored even when the iodine adsorption, bromine adsorption, and chlorine adsorption compete against each other, because the halogen adsorbent has high selectivity for iodide ions.

It is to be noted that the color tone changes depending on the introduction rates of —NR¹—(CH₂CH₂NR³)ₙ—R² as a ligand that depends on the reaction condition, and of the CH₂CH₂CONR⁴R⁵ group as a substituent for R¹, R², and R³, and the adsorption amount of halogen, the numerical value of the wavelength mentioned above thus works out only for the specific sample, and preferred wavelengths can be selected appropriately depending on synthesized adsorbents.

As described above, the halogen adsorbent according to the embodiment can be also used as a reagent for detecting bromide ions, iodide ions, and chloride ions. While the detection can be performed visually such as colorimetrically, it is also possible to perform the detection by the UV-Vis spectrum measurement described above, or reflection spectrum measurement.

The color change of the halogen adsorbent can be confirmed from, for example, an observation window of a tank with the halogen adsorbent contained therein. The method of confirmation is preferably colorimetric, the UV-Vis spectrum measurement, and the reflection spectrum measurement as described above. In addition, the tank with the halogen adsorbent contained therein is also preferably opened to analyze the adsorbent with halogen adsorbed thereon colorimetrically, or by UV-Vis spectrum measurement or reflection spectrum measurement.

Furthermore, in the same way, it is also possible to perform monitoring of the adsorption amount colorimetrically, or by UV-Vis spectrum measurement or reflection spectrum measurement. Thus, it becomes possible to exchange the adsorbent before any breakthrough and after adequately running out of the adsorption capacity.

It is also possible to use the above-described adsorbent which undergoes a color change by halogen adsorption and an adsorbent which undergoes no color change by halogen adsorption in combination.

(Method for Manufacturing Halogen Adsorbent)

Next, a method for manufacturing the halogen adsorbent according to the present embodiment will be described in detail. However, the manufacturing method described below is by way of example, and there is not to be considered any particular limit to the method as long as the halogen adsorbent according to the present embodiment is obtained. It is to be noted that after carrying out each treatment, the next treatment is preferably carried out after carrying out filtration, washing with pure water, alcohol, or the like, and drying.

First, the support such as silica or titania is prepared, and the surface of the support is treated with a chelate ligand or a coupling agent including a functional group that can form the chelate ligand by modification to introduce the chelate ligand to the surface of the support. Examples of the coupling agent including the chelate ligand include coupling agents such as N-(2-aminoethyl)-3-aminopropyltrimethoxysilane, N-(2-aminoethyl)-3-aminopropyltriethoxysilane, N-(2-aminoethyl)-3-aminopropyldimethoxymethylsilane, and N—(N-(2-aminoethyl)-2-aminoethyl)propyltrimethoxysilane.

In addition, in the case of using a chelate ligand including a CH₂CH₂CONR⁴R⁵ group, 3-aminopropyltrimethoxysilane and 3-aminopropyldiethoxymethylsilane can be also used.

For the reaction between the coupling agent and the support, there are: a method of reacting the vaporized coupling agent with the support; a method of mixing the coupling agent in a solvent to mix the coupling agent with the support for the reaction; and a method of reacting in direct contact with the support without using any solvent. In each reaction, the amount of the chelate ligand introduced to the support surface can be adjusted by carrying out heating or pressure reduction.

For the introduction of the CH₂CH₂CONR⁴R⁵ group, there are: a method of reacting the support treated with a silane coupling agent, with an acrylamide; and a method of reacting a silane coupling agent with an acrylamide, and then with the support. For the reaction, there are: a method of reacting in a solvent; and a method of reacting without using any solvent, and in the case of using no solvent, the reaction is developed at a temperature equal to or higher than the melting point of the acrylamide. It is to be noted that the acrylamide is an organic compound having a vinyl group and an amide group.

The introduction amount changes depending on the reaction temperature and time, and the amount of solvent. The optimum reaction temperature and time, and amount of solvent depend on whether a solvent is used or not, and on the type of the solvent. The appropriate selection of an optimum condition can achieve modification with the CH₂CH₂CONR⁴R⁵ group at a desired introduction rate. It is to be noted that from the perspective of introducing at least one CH₂CH₂CONR⁴R⁵ group on average to the reactive functional group, the reaction system for the introduction of the CH₂CH₂CONR⁴R⁵ group preferably includes therein an amount of acrylamide that is able to react with the reactive substituent more than 33% of the reactive functional group present on the support.

Further, examples of the acrylamide include acrylamide, N-methyl acrylamide, N-ethyl acrylamide, N-isopropyl acrylamide, N-tert-butyl acrylamide, diacetone acrylamide, N-hydroxymethyl acrylamide, N-butoxymethyl acrylamide, N,N-dimethyl acrylamide, and N,N-diethyl acrylamide, and the functional group on nitrogen may be any group as long as an acrylamide is adopted.

In addition, in the case of reacting the support treated with a silane coupling agent, with the acrylamide, solvents that can be used can include water, methanol, ethanol, n-propanol, isopropanol, 2,2,2-trifluoroethanol, acetone, methyl ethyl ketone, tetrahydrofurane, 2-methyltetrahydrofuran, 1,4-dioxane, 1,3-dioxane, n-hexane, cyclohexane, heptane, octane, toluene, acetonitrile, N,N-dimethylformamide, N,N-dimethylacetoamide, dimethylsulfoxide, N-methylpyrrolidon, and mixtures thereof.

In the case of reacting the silane coupling agent with the acrylamide first, solvents that can be used can include methanol, ethanol, n-propanol, isopropanol, 2,2,2-trifluoroethanol, acetone, methyl ethyl ketone, tetrahydrofurane, 2-methyltetrahydrofuran, 1,4-dioxane, 1,3-dioxane, n-hexane, cyclohexane, heptane, octane, toluene, acetonitrile, N,N-dimethylformamide, N,N-dimethylacetoamide, dimethylsulfoxide, N-methylpyrrolidon, and mixtures thereof. The use of a dehydrated solvent produce a more favorable result.

It is to be noted that catalysts, polymerization inhibitors, and the like can be added, if necessary. Also in this case, the reaction described above can be progressed with more certainty.

Then, the metal ion is supported onto the support obtained in the way described above. Examples of the method for supporting the metal ion can include, for example, a method of preparing an aqueous solution with the use of a predetermined reagent, and then stirring with the support immersed in the aqueous solution; or a method of filling a tank or column with the support, and flowing the aqueous solution into the tank or column.

It is to be noted that while a coupling agent is used for the introduction of the chelate ligand to the support surface in the manufacturing method described above, it is also possible to introduce a reactive functional group to the support surface in advance, and then introduce the chelate ligand. Examples thereof can include, for example, a method of introducing an epoxy group to the support surface, and reacting the epoxy group with a compound having a site that reacts with the epoxy group.

(Water Treatment System and Method for Using Halogen Adsorbent)

Next, an adsorption system with the use of the halogen adsorbent described above and a method for using the system will be described. The water treatment system including an adsorbent unit having a halogen adsorbent, a supplying unit supplying target medium including halogen for the halogen adsorbent of the adsorbent unit, a discharging unit discharging the target medium from the adsorbent unit, a measuring unit measuring concentration of halogen in the target medium provided in the supplying unit side and/or the discharging unit side, and a controller controlling flow of the target medium from the supplying unit to the adsorbent unit when a value calculated from the measured value of concentration in the measuring unit reaches set value.

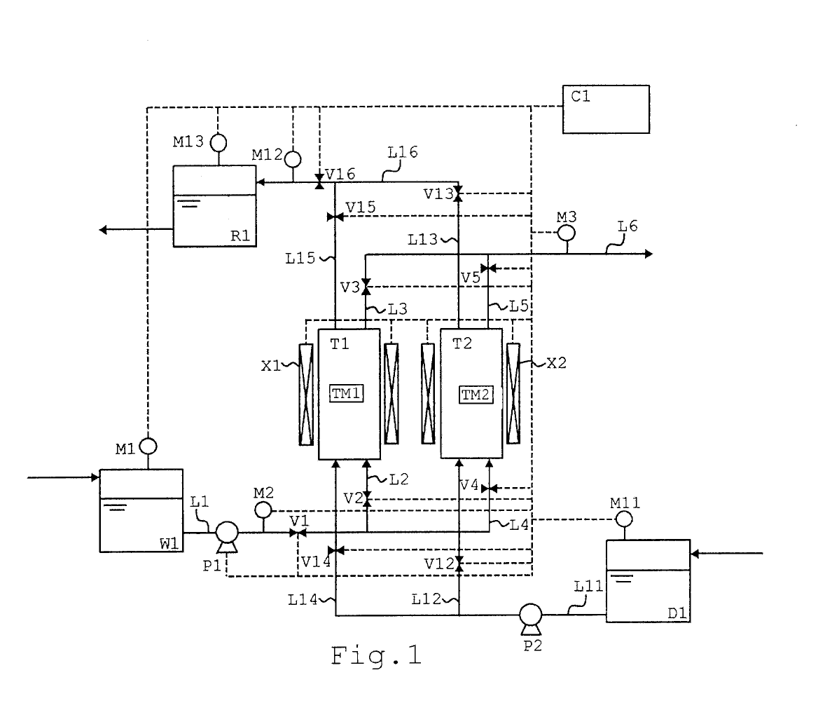

FIG. 1 is a conceptual diagram illustrating a schematic configuration and a treatment system for an apparatus for use in halogen adsorption according to the present embodiment.

As shown in FIG. 1, in this apparatus, tanks (adsorbent unit) T1 and T2 for water treatment are arranged in parallel, which are filled with the halogen adsorbent described above, and contact efficiency promoting means X1 and X2 are provided lateral to the tanks T1 and T2 for water treatment. The contact efficiency promoting means X1 and X2 can be mechanical stirring devices or non-contact magnetic stirring devices, which are, however, indispensable components, and may be omitted.

In addition, a discharged water storage tank W1 that storages discharged water (target medium) containing halogen is connected through discharged water supply lines (supplying unit) L1, L2, and L4 to the tanks T1 and T2 for water treatment, and connected externally through discharged water discharge lines (discharging unit) L3, L5, and L6.

Further, the supply lines L1, L2, and L4 are provided respectively with valves (controller) V1, V2, and V4, and the discharge lines L3 and L5 are provided respectively with valves V3 and V5. In addition, the supply line L1 is provided with a pump P1. Furthermore, the discharged water storage tank W1, the supply line L1, and the discharge line L6 are provided respectively with concentration measurement means (measuring unit) M1, M2, and M3.

In addition, in the case of using a adsorbent that undergoes a color change by halogen adsorption, it is also possible to monitor the adsorption amounts in the tanks T1 and T2 for water treatment by monitoring the color of the adsorbent with monitoring means (measuring unit) TM1 and TM2 provided in the tanks for water treatment. It is preferable that the measuring concentration of halogen in the target medium and color of the halogen adsorbent are conducted sequentially. While both the tanks T1 and T2 respectively have the monitoring means TM1 and TM2 in FIG. 1, either one of the tanks may be provided with the monitoring means. The monitoring means TM1 and TM2 preferably includes a window, or includes a window and at least any one of a UV-Vis spectrum measurement device, a reflection spectrum measurement device, and an imaging device.

The simplest means is a window that is capable of interior observations of TM1 and TM2, and can visually or colorimetrically achieve monitoring of the adsorption amounts.

The adsorption amounts can be also monitored by providing TM1 and TM2 with a measurement device for UV-Vis spectra or reflection spectra to observe the color.

Although not shown in the figure, in the case of using a UV-Vis spectrum measurement device or a reflection spectrum measurement device for the monitoring means TM1 and TM2, the measurement devices preferably include an operation computer (controller) and a display device to make a measurement at required timing and display the adsorption amounts for the observer. In the case of a UV-Vis spectrum measurement device or a reflection spectrum measurement device, for example, the computer can be used to figure out the intensity or absorbance ratio for light of wavelengths of 450 nm and 650 nm from a measured spectrum, and estimate the adsorption amount from the intensity or absorbance ratio between before a water treatment and during the water treatment or after the water treatment.

In the case of colorimetric monitoring, the adsorbed amounts can be monitored by taking an image from the window with the use of an imaging device such as a digital camera or a video camera, and observing the color of the adsorbent from the image. In addition, the adsorption amounts can be also estimated by collecting samples of the adsorbent from the tanks T1 and T2, and observing the colors of the sampled adsorbents. Also in the case of using imaging devices as monitoring means TM1 and TM2, the devices are preferably connected to a computer (controller) and a display device, not shown, to display, for the observer, the adsorption amounts estimated from color information obtained by imaging.

At least any one of the intensity or absorbance ratio, the color of the adsorbent, and the adsorption amounts estimated can be compared with a reference value set depending on conditions such as the adsorbent structure and the water to be treated, to determine the timing for recycling or exchanging the adsorbent.

The control of the valves and pumps mentioned above and the monitoring of the measurement values in the measurement device are collectively controlled centrally by a control means C1.

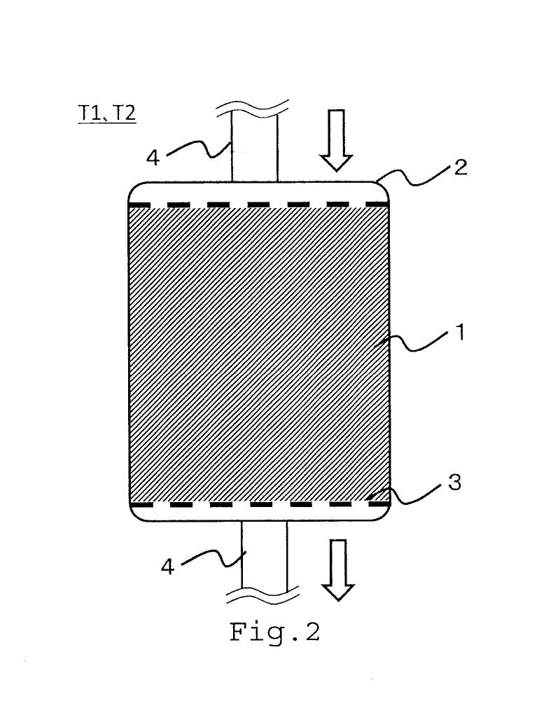

FIG. 2 shows a conceptual cross-sectional view of the tank T1, T2 for water treatment, which is connected to piping 4 (L2 to L4), and filled with the halogen adsorbent. The arrow in the figure indicates a direction in which treated water (target medium) flows. The tank T1, T2 for water treatment is composed of a halogen adsorbent 1, a tank 2 containing the halogen adsorbent, and a partition plate 3 for keeping the halogen adsorbent from leaking outside the tank 2. The tank T1, T2 for water treatment may have the form of a cartridge type with the tank 2 itself exchangeable, or may have the form with the exchangeable halogen adsorbent in the tank 2. When there is anything to be adsorbed and collected besides halogen, other adsorbents can be contained in the tank 2.

Next, the operation for adsorbing halogen with the use of the apparatus shown in FIG. 1 will be described.

First, discharged water is supplied by the pump P1 from the tank W1 through the discharged water supply lines L1, L2, and L4 to the tanks T1 and T2 for water treatment. In this case, halogen in the discharged water is adsorbed in the tanks T1 and T2 for water treatment, and the discharged water after the adsorption is discharged to the outside through the discharged water discharge lines L3 and L5.

In this case, if necessary, the contact efficiency promoting means X1 and X2 can be driven to increase the area of contact between the halogen adsorbent filling the tanks T1 and T2 for water treatment and the discharged water, and thereby improve the halogen adsorption efficiency in the tanks T1 and T2 for water treatment.

The adsorbed states in the tanks T1 and T2 for water treatment are observed with the concentration measurement means M2 provided on the supply side and the concentration measurement means M3 provided on the discharge side. When adsorption proceeds smoothly, the halogen concentration measured by the concentration measurement means M3 has a lower value than the halogen concentration measured by the concentration measurement means M2. However, as halogen adsorption gradually proceeds in the tanks T1 and T2 for water treatment, the difference in the halogen concentration is decreased between the concentration measurement means M2 and M3 arranged respectively on the supply side and the discharge side.

Therefore, when the concentration measurement means M3 reaches a predetermined value set in advance to determine that the halogen adsorption capacity of the tanks T1 and T2 for water treatment is saturated, the control means C1 stops the pump P1 and closes the valve V2, V3, and V4 to stop the supply of the discharged water to the tanks T1 and T2 for water treatment, on the basis of information from the concentration measurement means M2 and M3.

In the case of using an adsorbent that undergoes a color change with halogen adsorption, the use of the monitoring means TM1 and TM2 in the tanks, which can directly observe the inside of T1 and T2 can directly monitor the adsorption amounts of halogen. Unlike a case of using the concentration measurement means M3, the adsorbent can be exchanged before the halogen adsorbent is saturated, and the halogen concentration on the discharge side can be kept low.

In addition, the halogen treatment system can be used as a domestic water purifier. In this case, water can be treated by placing the tank T1 for water treatment in the middle of the flow path of tap water. In this case, the use of an adsorbent that undergoes a color change with halogen adsorption can keep a tally of the adsorption amount by providing a window as the monitoring means TM1 in the tank, the adsorbent can be exchanged before reaching the saturation. Although expensive, a UV-Vis spectrum or reflection spectrum measurement device may be used as TM1. In addition, more simply, water can be also treated in the same manner by placing, in a container, a cartridge, a bag, or the like with the adsorbent put therein, and storing halogen-containing water in the cartridge, bag, or the like.

It is to be noted that, although not shown in FIG. 1, when the discharged water fluctuates in pH, or when the pH, which indicates strong acidity or strong alkaline, departs from a pH range that is suitable for the adsorbent according to the present embodiment, the pH of the discharged water may be measured with the concentration measurement means M1 and/or M2 to adjust the pH of the discharged water through the control means C1. Preferred pH is, for example, 2 or more and 8 or less for iodine adsorption of the halogen adsorbent according to the present embodiment. While it is virtually difficult to treat raw water for tap water, tap water, water for agricultural use, water for industrial use, and the like after the pH adjustment, it is also possible to treat these kinds of water without any pH adjustment.

In addition, filling the outlet sides of T1 and T2 with a support modified only with the ligand can reduce the amount of metal contained in the discharge, if the metal should be eluted from the halogen adsorbent. In addition, a similar effect can be produced even in the case of using activated carbon, chelate resin, or ion-exchange resin.

After the tanks T1 and T2 for water treatment are saturated, the tanks are exchanged appropriately for tanks for water treatment, which are filled with a new halogen adsorbent, and the tanks T1 and T2 for water treatment which are saturated are subjected to a required post-treatment appropriately. For example, when the tanks T1 and T2 for water treatment contain radioactive iodine, for example, the tanks T1 and T2 are crushed, then solidified with cement, and housed as radioactive waste in an underground facility or the like.

It is to be noted that while the system with the use of tanks for water treatment and operation thereof for adsorbing halogen in discharged water have been described in the example given above, halogen in exhaust gas can be adsorbed and removed by blowing the halogen-containing exhaust gas into the tanks as described above.

### Example 1

In a recovery flask (200 mL) with a cooling tube, a silica gel (12 g, from 100 μm to 210 μm in particle size (the same applied hereinafter)), toluene (40 mL), and water (6 mL) were added, and stirred until the water was all absorbed by the silica gel. N-(2-aminoethyl)-3-aminopropylsilane (24 mL) was added thereto, and reacted for 5 hours under reflux with toluene. After removing the liquid layer by decantation, 20 mL of toluene was added for washing, and the washing operation for removing the liquid layer by decantation was again carried out three times. Furthermore, 70 mL of toluene was added for washing for 30 minutes under reflux with toluene. After cooling to room temperature, the silica gel was collected by suction filtration. The silica gel was thoroughly washed with toluene and water, and then dried under the atmosphere. Subsequently, through drying under reduced pressure, and furthermore drying for 3 hours in an oven at 110° C., ethylenediamine-modified silica gel (15 g) was obtained. The ethylenediamine-modified silica gel (0.50 g) was taken into a vial, and stirred for 1 hour with the addition of a 5 wt % copper (II) nitrate aqueous solution (10 mL) thereto. The solid constituent was collected by suction filtration, and dried under the atmosphere. Furthermore, the solid constituent was dried under reduced pressure to synthesize a halogen adsorbent (0.52 g) according to Example 1.

### Example 2

The ethylenediamine-modified silica gel (0.50 g) according to Example 1 was taken into a vial, and stirred for 1 hour with the addition of N,N′-dimethylethylenediamine (0.1 mL) and a 5 wt % copper (II) nitrate aqueous solution (10 mL) thereto. The solid constituent was collected by suction filtration, and dried under the atmosphere. Furthermore, the solid constituent was dried under reduced pressure to synthesize a halogen adsorbent (0.52 g) according to Example 2.

### Example 3

A silica gel (0.20 g) with a triethylenediamine ligand was taken into a vial, and immersed for 1 hour with the addition of a 5 wt % copper (II) nitrate aqueous solution (4 mL) thereto. The solid constituent was collected by suction filtration, and dried under the atmosphere. Furthermore, the solid constituent was dried under reduced pressure to obtain a halogen adsorbent (0.20 g) according to Example 3.

### Example 4

N-(2-aminoethyl)-3-aminopropylsilane (8.4 g) was taken into a recovery flask (50 mL) with a cooling tube, and dissolved with the addition of toluene (20 mL). A silica gel (6.4 g) was added thereto, and reacted for 8 hours under reflux with toluene. After cooling to room temperature, the solid constituent was collected by suction filtration. The collected solid constituent was thoroughly washed with toluene, then dried under the atmosphere, and further dried under reduced pressure to obtain an ethylenediamine-modified silica gel (8.1 g). The ethylenediamine-modified silica gel (0.51 g) and N-isopropylacrylamide (1.5 g) were taken into a recovery flask (50 mL), heated while stirring to melt the N-isopropylacrylamide, and reacted directly for 7.5 hours. After cooling to room temperature, acetone was added to dissolve the N-isopropylacrylamide, and the solid constituent was collected by suction filtration, and thoroughly washed with acetone and water. The cleaned solid constituent was dried under the atmosphere, and then further dried under reduced pressure to obtain an N-isopropylacrylamide-ethylenediamine-modified silica gel (0.54 g). The N-isopropylacrylamide-ethylenediamine-modified silica gel (0.20 g) was taken into a vial, and stirred for 1 hour with the addition of a 5 wt % copper (II) nitrate aqueous solution (4 mL) to the vial. The solid constituent was collected by suction filtration, and dried under the atmosphere. The dried solid constituent was further dried under reduced pressure to obtain a halogen adsorbent (0.21 g) according to Example 4.

### Example 5

A halogen adsorbent according to Example 5 was obtained in the same way as in Example 4 except that the N-isopropylacrylamide was changed to N-butoxymethylacrylamide.

### Example 6

A halogen adsorbent according to Example 6 was obtained in the same way as in Example 4 except that the N-isopropylacrylamide was changed to N-butoxymethylacrylamide, and that the copper (II) nitrate was changed to iron (III) nitrate.

### Example 7

A halogen adsorbent according to Example 7 was obtained in the same way as in Example 4 except that the N-isopropylacrylamide was changed to N-butoxymethylacrylamide, and that the copper (II) nitrate was changed to zinc (II) nitrate.

### Example 8

N,N-dimethylacrylamide (5.2 mL) and N-(2-aminoethyl)-3-aminotrimethoxysilane (4.1 mL) were added to acetonitrile (50 mL), and heated to reflux for 3 hours. Subsequently, acetonitrile (50 mL), water (20 mL), and silica gel (2.0 g) were added thereto, and reacted at 80° C. for 1 hour. After cooling to room temperature, the precipitated solid constituent was collected, and thoroughly washed with acetone and water. The cleaned solid constituent was dried under the atmosphere, and then further dried under reduced pressure to obtain an N,N-dimethylacrylamide-ethylenediamine-modified silica gel (2.4 g). The N,N-dimethylacrylamide-ethylenediamine-modified silica gel (0.20 g) was taken into a vial, and immersed for 1 hour with the addition of a 5 wt % copper (II) nitrate aqueous solution (4 mL) to the vial. The solid constituent was collected by suction filtration, and dried under the atmosphere. The dried solid constituent was dried under reduced pressure to obtain a halogen adsorbent (0.21 g) according to Example 8.

### Example 9

N-(2-aminoethyl)-3-aminopropylsilane (1.5 g) and N-butoxymethylacrylamide (2.1 g) were taken into a recovery flask (50 mL), and reacted for 5 hours while being heated to reflux with the addition of acetonitrile (5 mL). Cooling was carried out to such an extent that the reflux was stopped, and silica gel (3.0 g) and water (0.37 mL) were added to develop a reaction for 3 hours again while being heated to reflux. After removing the liquid layer by decantation, the silica gel was collected by suction filtration, and thoroughly washed with acetone and water. After drying under the atmosphere, through drying for 3 hours in an oven at 110° C., N-butoxymethylacrylamide-ethylenediamine-modified silica gel (4.6 g) was obtained. The N-butoxymethylacrylamide-ethylenediamine-modified silica gel (0.50 g) was taken into a vial, and stirred for 1 hour with the addition of a 5 wt % copper (II) nitrate aqueous solution (10 mL) thereto. The solid constituent was collected by suction filtration, and dried under the atmosphere. Furthermore, the solid constituent was dried under reduced pressure to synthesize a halogen adsorbent (0.52 g) according to Example 9.

### Example 10

A silica gel (5.0) was taken into a recovery flask (500 mL), and dispersed with the addition of an ethanol/water mixed solvent (5:1, v/v, 300 mL). To this dispersion, 3-aminopropyltrimethoxysilane (12 g) was added to develop a reaction at 80° C. for 1 hour. Then, after cooling to room temperature, the silica gel was collected by suction filtration. The silica gel was thoroughly washed with ethanol, then dried under the atmosphere, and further dried under reduced pressure to obtain an amine-modified silica gel (5.7 g). The amine-modified silica gel (0.20 g) was taken into a vial, and allowed to stand still for 1 hour with the addition of a 5 wt % copper (II) nitrate aqueous solution (10 mL) thereto. The solid constituent was collected by suction filtration, and dried under the atmosphere. The solid constituent (0.22 g) was obtained by further drying under reduced pressure. The solid constituent (0.51 g) and N-isopropylacrylamide (0.95 g) were taken into a recovery flask (50 mL), heated while stirring to melt the N-isopropylacrylamide, and reacted directly for 7.5 hours. After cooling to room temperature, acetone was added to dissolve the N-isopropylacrylamide, and the modified silica gel was collected by suction filtration, and thoroughly washed with acetone and water. The modified silica gel was dried under the atmosphere, and then further dried under reduced pressure to obtain an N-isopropylacrylamide-amine-modified silica gel (0.57 g). The synthesized N-isopropylacrylamide-amine-modified silica gel (0.20 g) was taken into a vial, and allowed to stand still for 1 hour with the addition of a 5 wt % copper (II) nitrate aqueous solution (10 mL) thereto. The solid constituent was collected by suction filtration, and dried under the atmosphere. Furthermore, the solid constituent was dried under reduced pressure to synthesize a halogen adsorbent (0.22 g) according to Example 10.

### Comparative Example 1

A silica gel (0.50 g) was taken into a vial, and immersed for 1 hour with the addition of a 5 wt % copper (II) nitrate aqueous solution (10 mL) thereto. The solid constituent was collected by suction filtration, and dried under the atmosphere. Furthermore, the solid constituent was dried under reduced pressure to obtain a halogen adsorbent (0.50 g) according to Comparative Example 1.

### Comparative Example 2

The amine-modified silica gel (0.50 g) synthesized in Example 6 was taken into a vial, and immersed for 1 hour with the addition of a 5 wt % copper (II) nitrate aqueous solution (10 mL) thereto. The solid constituent was collected by suction filtration, and dried under the atmosphere. Furthermore, the solid constituent was dried under reduced pressure to obtain a halogen adsorbent (0.56 g) according to Comparative Example 2.

### Comparative Example 3

Commercially available zeolite supported silver was used as a halogen adsorbent according to Comparative Example 3.

### Comparative Example 4

Commercially available silver-impregnated activated carbon was used as a halogen adsorbent according to Comparative Example 4.

[Iodine Adsorption Test]

In a 1 L measuring flask, 1.000 g of potassium iodide was put, and diluted with pure water to prepare a 1000 ppm (mg/L) potassium iodide aqueous solution. Ina 250 mL measuring flask, 125 mL of the solution was put, and diluted with pure water to prepare a 500 ppm potassium iodide aqueous solution. In addition, after adding 0.125 g of sodium chloride to 125 mL of the 1000 ppm potassium iodide aqueous solution, the solution was diluted to 250 mL total to prepare a 500 ppm potassium iodide aqueous solution containing 500 ppm sodium chloride. In addition, after adding 0.125 g of potassium bromide to 125 mL of the 1000 ppm potassium iodide aqueous solution, the solution was diluted to 250 mL total to prepare a 500 ppm potassium iodide aqueous solution containing 500 ppm potassium bromide.

Then, in a 20 mL vial, 10 mL of the iodine adsorption test solution and 20 mg of the adsorbent were added, and stirred for 1 hour under the condition of 60 rpm under room temperature with the use of a mix rotor. Promptly after the completion of stirring, filtration was carried out through a cellulose membrane filter of 0.2 μm.

The iodine concentration of the filtrate was quantified by ion chromatography. Specifically, 1.8 mL of water was added to 0.2 mL of the filtrate for dilution to 1/10. The alliance 2695 from Nihon Waters K.K. was used for a ion chromatograph system, and Shodex IC SI-90 4E and a 1.8 mM sodium carbonate-1.7 mM sodium hydrogen carbonate aqueous solution were used respectively for a column and an eluent. For the adsorption amount, the iodine concentration was calculated by adopting the difference in the amount residual iodide ion from a blank subjected to the same operation without putting the adsorbent. The amount of iodine adsorption was calculated from the iodine concentration, and the amount of iodine adsorption was figured out from the amount of the adsorbent used.

Table 1 shows the results of carrying out the test described above, with the use of the halogen adsorbents according to Examples 1 to 10 and Comparative Examples 1 to 4. It is to be noted that the adsorption amount A refers to the adsorption amount [mg-I/g] with respect to the 500 ppm KI solution. In addition, the adsorption amount B refers to the adsorption amount [mg-I/g] with respect to the 500 ppm KI—NaCl solution. In addition, the adsorption amount C refers to the adsorption amount [mg-I/g] with respect to the 500 ppm KI—KBr solution. In the table, CH₂CH₂CONR⁴R⁵ is denoted by X. It is to be noted that the reaction may fail to proceed at 1000, and R in the table is thus indicative of containing a ligand having such a substituent, but not to be considered to mean that all of the ligands have only the substituent in the table.

TABLE 1

| | Amount | Amount | Amount | | | | | | |
|---|---|---|---|---|---|---|---|---|---|
| Halogen | A | B | C | | | | | | |
| Adsorbent | [mg-I/g] | [mg-I/g] | [mg-I/g] | R¹ | R² | R³ | R⁴ | R⁵ | n |
| Example 1 | 100 | 70 | 69 | H | H | H | — | H | 1 |
| Example 2 | 99 | 78 | — | H | H | H | — | H | 1 |
| Example 3 | 84 | 43 | — | H | H | H | — | H | 2 |
| Example 4 | 112 | 79 | — | X | X | X | I | H | 1 |
| Example 5 | 97 | 77 | — | X | X | X | B | H | 1 |
| Example 6 | 79 | 61 | — | X | X | X | B | H | 1 |
| Example 7 | 44 | 36 | — | X | X | X | B | H | 1 |
| Example 8 | 99 | 65 | — | X | X | X | M | M | 1 |
| Example 9 | 102 | 72 | 79 | X | X | X | B | H | 1 |
| Example 10 | 74 | 54 | — | X | X | — | I | — | 0 |
| Comparative | 0 | 0 | — | — | — | — | — | — | — |
| Example 1 | | | | | | | | | |
| Comparative | 31 | 14 | — | H | H | — | — | — | 0 |
| Example 2 | | | | | | | | | |
| Comparative | 15 | 12 | — | — | — | — | — | — | — |
| Example 3 | | | | | | | | | |
| Comparative | 21 | 17 | — | — | — | — | — | — | — |
| Example 4 | | | | | | | | | |

Amount A: Absorption Amount A
Amount B: Absorption Amount B
Amount C: Absorption Amount C
H: Hydrogen
I: Isopropyl
B: Butoxymethyl
M: Methyl

As is clear from Table 1, it is determined that the halogen adsorbents obtained in the examples are excellent in the iodine adsorption amount in the potassium iodide aqueous solution to the silver-impregnated activated carbon (Comparative Example 3) and the zeolite supported silver (Comparative Example 4). In addition, when the aqueous solution contains the other constituent (sodium chloride or potassium bromide in the examples), the adsorbents exhibits favorable iodine adsorption capacities in spite of performance degradation.

From the result of Comparative Example 1, it is determined that no iodine adsorption capacity is provided when the silica gel has no ligand thereon. This is considered to be because the copper ion is not immobilized on the silica gel surface.

In addition, in comparison between Comparative Examples 2, 3, and 4 and the examples, the performance in the potassium iodide aqueous solution is superior to the supported silver materials in the case of having no chelate ligand, while the performance is decreased to the same degree as the silver-supported materials (Comparative Examples 3 and 4) when the aqueous solution contains therein the other constituent (sodium chloride in the example). It is determined that the use of the chelate ligand makes the iodine adsorption amount in the potassium iodide aqueous solution twice or more as large as that in the case of a monodentate ligand, and achieves a high iodine adsorption capacity even when the constituent other than iodine (sodium chloride in the example) is present. This is the ion-exchange promoting effect of the chelate ligand.

Furthermore, in comparison among Examples 4, 5, and 8, it has been determined that as the alkyl substituent on the amide group is larger like methyl<isopropyl<butoxymethyl, the adsorbent is less likely to be hindered by the other constituent (sodium chloride in the example) in the aqueous solution. This is considered due to the contribution of the van der Waals' force acting between iodine and the alkyl chain. In addition, in comparison between Examples 1 and 2, it has been determined that Example 2 with the ligand (N,N′-dimethylethylenediamine in the example) added for supporting the metal is less likely to be hindered by the other constituent. This is considered to be because the addition of the ligand makes the supported copper likely to form a planar four-coordination structure as in Chemical Formula 2.

Examples 5, 6, and 7 refer to the halogen adsorbents respectively with copper (II) ions, iron (III) ions, and zinc (II) ions supported on the same supports, and the highest iodine adsorption capacity is exhibited when the copper ions are supported. From this comparison, it is determined that the copper ions are preferred.

In addition, the halogen adsorbents according to Examples 4, 5, and 9, which were blue before the test, underwent a color change to green after use. From this change, it is determined that the adsorbents can be used as reagents for detecting iodine. In addition, the adsorption amount for the change in color can be monitored colorimetrically, or by UV-Vis spectrum measurement or reflection spectrum measurement, because the color change proceeds gradually.

It is to be noted that the change in color by iodine adsorption was not observed in Examples 6 and 7 respectively with iron (III) ions and zinc (II) ions supported.

[Bromine Adsorption Test]

In a 1 L measuring flask, 1.000 g of potassium bromide was put, and diluted with pure water to prepare a 1000 ppm potassium bromide aqueous solution. In a 250 mL measuring flask, 125 mL of the solution was put, and diluted with pure water to prepare a 500 ppm potassium bromide aqueous solution. In addition, after adding 0.125 g of sodium chloride to 125 mL of the 1000 ppm potassium bromide aqueous solution, the solution was diluted to 250 mL total to prepare a 500 ppm potassium bromide aqueous solution containing 500 ppm sodium chloride. In addition, the 500 ppm potassium iodide aqueous solution containing 500 ppm potassium bromide was also used which was prepared in the iodine adsorption test.

Then, the same operation as in the iodine adsorption test was performed to figure out the bromine adsorption amount. Table 2 shows the results of carrying out the test described above, with the use of the halogen adsorbents obtained in the examples. It is to be noted that the adsorption amount D refers to the adsorption amount [mg-Br/g] with respect to the 500 ppm KBr solution. In addition, the adsorption amount E refers to the adsorption amount [mg-Br/g] with respect to the 500 ppm KBr—NaCl solution. In addition, the adsorption amount F refers to the adsorption amount [mg-Br/g] with respect to the 500 ppm KBr—KI solution. In the table, CH₂CH₂CONR⁴R⁵ is denoted by X. It is to be noted that the reaction may fail to proceed at 100%, and R in the table is thus indicative of containing a ligand having such a substituent, but not to be considered to mean that all of the ligands have only the substituent in the table.

TABLE 2

| | Amount | Amount | Amount | | | | | | |
|---|---|---|---|---|---|---|---|---|---|
| | D | E | F | | | | | | |
| Halogen | [mg- | [mg- | [mg- | | | | | | |
| Adsorbent | Br/g] | Br/g] | Br/g] | R¹ | R² | R³ | R⁴ | R⁵ | n |
| Example 1 | 66 | 46 | 43 | H | H | H | — | H | 1 |
| Example 9 | 48 | 39 | 23 | X | X | X | B | H | 1 |

Amount D: Absorption Amount D
Amount E: Absorption Amount E
Amount F: Absorption Amount F
H: Hydrogen
B: Butoxymethyl

It has been determined that Example 1 with hydrogen as R¹, R², and R³ exhibits a higher bromine adsorption amount than Example 9. This is considered to be because the contribution of the van der Waals' force is decreased to cause the alkyl chain to serve as steric hindrance in Example 9. This is expected from the fact that the hindrance by coexistent ions is significant in the case of iodine. Therefore, when the halogen is bromine, the ligand in Example 1 is preferred.

On the other hand, in Example 9, the adsorbent which was blue before the test underwent a change in color to blue-green after the test for obtaining the adsorption amounts D and E. The change in color is obvious in visual comparison, but obscurer as compared with the case of iodine. However, as described above, the adsorption can be monitored by tracking the UV-Vis spectrum or reflection spectrum. Further, the adsorbent underwent a color change to green after the test for obtaining the adsorption amount F.

In addition, the adsorption amount of the adsorbent according to Example 9 is smaller than that according to Example 1, and filling the water treatment tank with only Example 9 is thus disadvantageous in terms of adsorption amount. However, the use of Example 9 mixed with the adsorbent according to Example 1, for example, can achieve monitoring of the adsorption amount while maintaining the adsorption amount at a high level.

[Chlorine Adsorption Test]

Used were the 500 ppm potassium iodide aqueous solution containing 500 ppm sodium chloride, which was prepared in the iodine adsorption test, and the 500 ppm potassium bromide aqueous solution containing 500 ppm sodium chloride, which was prepared in the bromine adsorption test.

Then, the same operation as in the iodine adsorption test was performed to figure out the chlorine adsorption amount. Table 3 shows the results of carrying out the test described above, with the use of the halogen adsorbents obtained in the examples. It is to be noted that the adsorption amount G refers to the adsorption amount [mg-Cl/g] with respect to the 500 ppm KBr—NaCl solution. In addition, the adsorption amount H refers to the adsorption amount [mg-Cl/g] with respect to the 500 ppm KI—NaCl solution. In the table, CH₂CH₂CONR⁴R⁵ is denoted by X. It is to be noted that the reaction may fail to proceed at 100%, and R in the table is thus indicative of containing a ligand having such a substituent, but not to be considered to mean that all of the ligands have only the substituent in the table.

TABLE 3

| | Amount | Amount | | | | | | |
|---|---|---|---|---|---|---|---|---|
| Halogen | G | H | | | | | | |
| Adsorbent | [mg-Cl/g] | [mg-Cl/g] | R¹ | R² | R³ | R⁴ | R⁵ | n |
| Exmample 1 | 18 | 18 | H | H | H | — | H | 1 |
| Exmample 2 | 17 | — | H | H | H | — | H | 1 |
| Exmample 3 | 18 | — | H | H | H | — | H | 2 |
| Exmample 6 | 17 | — | X | X | X | B | H | 1 |
| Exmample 7 | 8 | — | X | X | X | B | H | 1 |
| Exmample 9 | 7 | 14 | X | X | X | B | H | 1 |
| Example 10 | 13 | — | X | X | — | I | — | 0 |

Amount G: Absorption Amount G
Amount H: Absorption Amount H
H: Hydrogen
B: Butoxymethyl
I: Isopropyl

It has been determined that Examples 1, 2, and 3 with hydrogen as R¹, R², and R³ exhibits a higher chlorine adsorption amount than Example 9 with CH₂CH₂CONR⁴R⁵. In addition, from the result of Example 6, it has been determined that chlorine can be adsorbed in a preferred fashion even when the supported metal is an iron (III) ion.

[Spectral Change with Halogen Adsorption]

The halogen adsorbent according to Example 9 was used to carry out iodine detection. A 1000 ppm KI aqueous solution was used to prepare 25-, 50-, 100-, and 250-ppm KI aqueous solutions. The halogen adsorbent (20 mg) according to Example 9 was weighed into each of four vials, and subsequently stirred for 1 hour with the addition of each of the 25-, 50-, 100-, and 250-ppm KI aqueous solutions. The adsorbent underwent a color change to blue-green in the case of 25 ppm, and a color change to green in the case of 50 ppm. The color change was obvious even visually, thus succeeding in iodine detection.

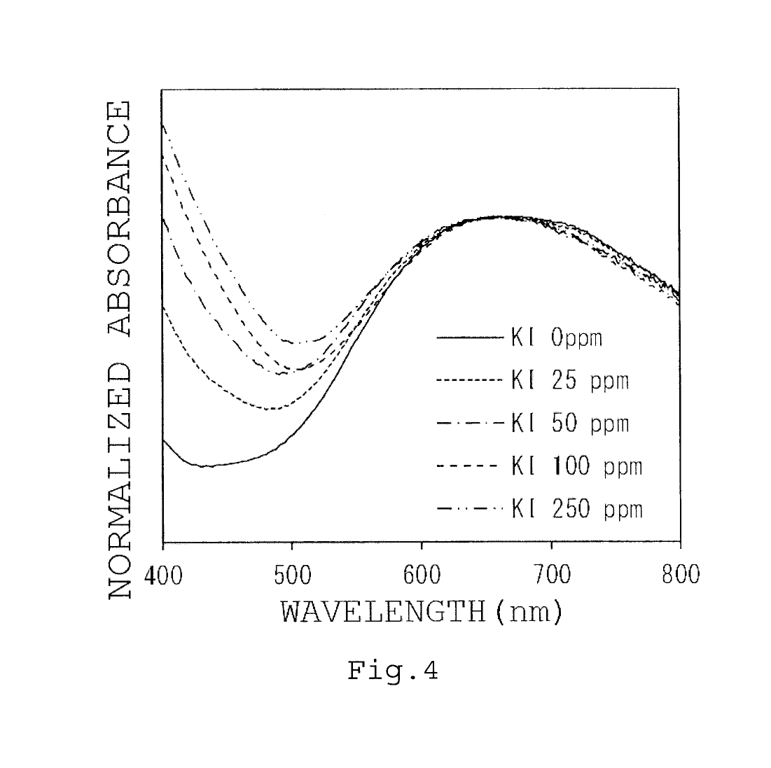

The halogen adsorbent after the test was collected by filtration, dried under reduced pressure, and then subjected to UV-Vis spectrum measurement. The spectra normalized at 650 nm are shown in FIG. 4. It has been determined that the absorbance from 400 to 600 nm is increased at all of the KI concentrations as compared with before adsorption (KI: 0 ppm), and there is a tendency for the absorbance to increase as the KI concentration increases. Therefore, the iodine adsorption can be monitored, for example, by figuring out the ratio between the absorbance at 450 nm and the absorbance at 650 nm.

The halogen adsorbent according to Example 9 was used to carry out iodine detection in coexistence with other halogen. The halogen adsorbent (20 mg) according to Example 9 was weighed into each of three vials, and subsequently stirred for 1 hour with the addition of each of the 500 ppm KI aqueous solution, 500 ppm KBr—KI aqueous solution, and 500 ppm NaCl—KI aqueous solution, which were used for the adsorption test. In each case, the halogen adsorbent underwent a color change to green. The color change was obvious even visually, thus succeeding in iodine detection.

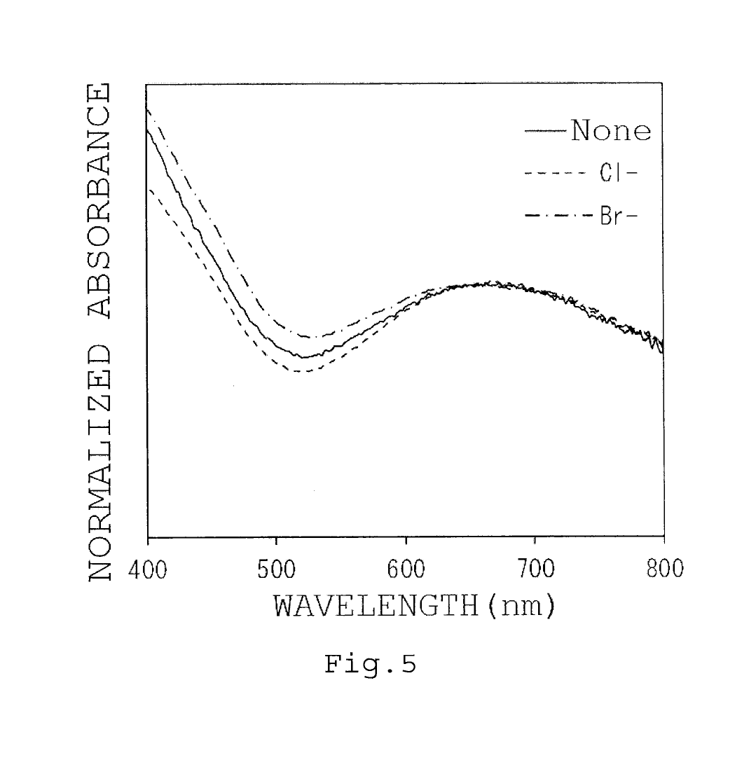

The halogen adsorbent after the test was collected by filtration, dried under reduced pressure, and then subjected to UV-Vis spectrum measurement. The spectra normalized at 650 nm are shown in FIG. 5. The absorbance from 400 to 600 nm is slightly higher in coexistence with bromine. This is because the absorption in the above range is also increased when bromine is adsorbed. In addition, the absorbance from 400 to 600 nm is slightly decreased in coexistence with chlorine. This is because there is almost no change in absorbance in this range when chlorine is adsorbed. The results mentioned above show that the adsorbent is able to selectively adsorb iodine in the presence of other halogen ions, and that it is possible to monitor the adsorption amount.

The UV-Vis spectrum measurement mentioned above was made in accordance with the following procedure. On soft paper or non-woven fabric, a glass slide of 1.2 mm thick was put, and a mask with a hole of 1 cm in diameter was put thereon. The sample was put into the hole, and spread thinly, and after removing the mask, the adsorbent was spread in one layer by tapping the glass slide. A drop of an acetone solution of polymethylmethacrylate (250 g/L) was put thereon with the use of a Pasteur pipette. After putting the drop, the adsorbent was dried while keeping the adsorbent spread in one layer by tapping the glass slide. After the glass slide was inclined and tapped to remove the unfixed excess sample, the glass slide with the sample fixed thereon was set in a sample holder so that light to be measured entered the glass surface, and subjected to UV-vis spectrum measurement by a transmission method with the use of an integrating sphere. It is to be noted that a mask with a hole of 1 cm in diameter was placed between the sample holder and the integrating sphere to make an adjustment so that the fixed sample was located coaxially with the hole. The measurement was made by combining UV-2500PC and MPC-2200 from Shimadzu Corporation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A halogen adsorbent comprising:
a support;
a chelate ligand bonded to the support; and
a metal ion coordinated on the chelate ligand,
wherein the chelate ligand has a functional group represented by —NR¹—(CH₂CH₂NR³)ₙ—R²,
all of the R¹, R², and R³ are hydrogen atoms and the n is 1 or 2, or
at least anyone of the R¹, R², and R³ is a functional group represented by —CH₂CH₂CONR⁴R⁵, the R⁴ and R⁵ are selected from a hydrogen atom, an alkyl group and an alkyl ether group including a straight chain or a side chain having 1 to 6 carbon atoms, and the n is any of 0, 1, and 2.

2. The adsorbent according to claim 1, wherein the metal ion is a copper ion.

3. The adsorbent according to claim 1, wherein the adsorbent is manufactured by a method comprising at least reacting the support with a silane coupling agent.

4. A tank for water treatment, the tank containing a halogen adsorbent comprising:
a support;
a chelate ligand bonded to the support; and
a metal ion coordinated on the chelate ligand,
wherein the chelate ligand has a functional group represented by —NR¹—(CH₂CH₂NR³)ₙ—R²,
all of the R¹, R², and R³ are hydrogen atoms and the n is 1 or 2, or
at least anyone of the R¹, R², and R³ is a functional group represented by —CH₂CH₂CONR⁴R⁵, the R⁴ and R⁵ are selected from a hydrogen atom, an alkyl group and an alkyl ether group including a straight chain or a side chain having 1 to 6 carbon atoms, and the n is any of 0, 1, and 2.

5. The tank according to claim 4, wherein the metal ion is a copper ion.

6. The tank according to claim 4, wherein the adsorbent is manufactured by a method comprising at least reacting the support with a silane coupling agent.

7. A water treatment system comprising:
an adsorbent unit having a halogen adsorbent;
a supplying unit supplying target medium including halogen for the halogen adsorbent of the adsorbent unit;
a discharging unit discharging the target medium from the adsorbent unit;
a measuring unit measuring concentration of halogen in the target medium provided in the supplying unit side and/or the discharging unit side; and
a controller controlling flow of the target medium from the supplying unit to the adsorbent unit when a value calculated from the measured value of concentration in the measuring unit reaches set value,
wherein the halogen adsorbent comprising:
a support;
a chelate ligand bonded to the support; and
a metal ion coordinated on the chelate ligand,
wherein the chelate ligand has a functional group represented by —NR¹—(CH₂CH₂NR³)ₙ—R²,
all of the R¹, R², and R³ are hydrogen atoms and the n is 1 or 2, or
at least anyone of the R¹, R², and R³ is a functional group represented by —CH₂CH₂CONR⁴R⁵, the R⁴ and R⁵ are selected from a hydrogen atom, an alkyl group and an alkyl ether group including a straight chain or a side chain having 1 to 6 carbon atoms, and the n is any of 0, 1, and 2.

8. The system according to claim 7, wherein the measuring unit measuring color of the halogen adsorbent and the controller estimating adsorbed amount of halogen from measured color of the adsorbent.

9. The system according to claim 7, wherein the measuring unit comparing a window, a UV-Vis spectrum measurement device, a reflection spectrum measurement device, or an imaging device for observing the color of the halogen adsorbent.

10. The system according to claim 7, wherein the measuring unit measuring concentration of halogen in the target medium or measuring the color of the adsorbent sequentially.

11. The system according to claim 7, wherein in the functional group of the adsorbent represented by the —NR¹—(CH₂CH₂NR³)ₙ—R², n=1, and at least two of R¹, R², and R³ are CH₂CH₂CONR⁴R⁵ groups, and the metal ion is a copper ion,
the system comprising a monitoring unit configured to observe a color of the halogen adsorbent, and
configured to estimate a halogen ion adsorption amount from the color of the halogen adsorbent, the color observed by the monitoring unit.

12. The system according to the claim 7, wherein the adsorbent unit is recycled or exchanged when the estimated adsorption amount of halogen is reached at set value.
